(19) United States
(12) Patent Application Publication
(10) Pub. No.: US 2026/0352131 A1
(43) Pub. Date: Nov. 5, 2026

(54) POLYPHASE MOTOR SWITCHING DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shintaro MORINO, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/125,373

(22) PCT Filed: Aug. 30, 2023
(86) PCT No.: PCT/JP2023/031379

§ 371 Date: Apr. 29, 2025

(30) Foreign Application Priority Data
Nov. 2, 2022 (JP) 2022-176082

(51) Int. Cl. H02P 25/18

(52) U.S. Cl. CPC H02P 25/188; H02P 2207/05

(57) ABSTRACT

There is provided a polyphase motor switching device that changes the characteristics of a polyphase motor while achieving a simplified structure. A polyphase motor switching device is used for a motor that includes polyphase coils, each of the coils having first coil parts and second coil parts. The polyphase motor switching device of the present disclosure includes a switching unit that changes the number of series connections of the first coil parts and the second coil parts in each of the coils.

### CROSS-REFERENCE TO RELATED APPLICATIONS

This application is the U.S. national stage of PCT/JP2023/031379 filed on Aug. 30, 2023, which claims priority of Japanese Patent Application No. JP 2022-176082 filed on Nov. 2, 2022, the contents of which are incorporated herein.

### TECHNICAL FIELD

The present disclosure relates to a polyphase motor switching device.

### BACKGROUND

JP 2020-162195A discloses a configuration in which a winding switching device switches the connection state of winding in a three phase alternate current motor between parallel winding and series winding.

As a configuration for switching the connection state between parallel winding and series winding, the configuration shown in FIG. 9 is conceivable. In this configuration, two coil parts 50 and 51 are connected by three relay switches 52, 53, and 54. In this case, the coil parts 50 and 51 can be connected in series by turning off the relay switches 52 and 54 and turning on the relay switch 53. In contrast, the coil parts 50 and 51 can be connected in parallel by turning on the relay switches 52 and 54 and turning off the relay switch 53. In the case of upsizing the relay switches 52, 53, and 54 in anticipation of a relatively large current flowing through the relay switches 52, 53, and 54, it is necessary to consider suppressing the mounting space.

### SUMMARY

An object of the present disclosure is to provide a polyphase motor switching device that changes the characteristics of a polyphase motor while achieving a simplified structure.

A polyphase motor switching device in the present disclosure is a polyphase motor switching device used in a polyphase motor including polyphase coils, each of the coils having a plurality of coil parts, and includes a switching unit that changes the number of series connections of the plurality of coil parts in each of the coils.

### ADVANTAGEOUS EFFECTS

It is possible to change the characteristics of a polyphase motor while achieving a simplified structure.

### BRIEF DESCRIPTION OF DRAWINGS

FIG. 1 is a schematic diagram of a motor according to a first embodiment.

FIG. 2 is a circuit diagram showing a configuration in which a polyphase motor switching device is provided in the motor according to the first embodiment.

FIG. 3 is a graph representing the relationship between the torque and rotation speed of the motor according to the first embodiment.

FIG. 4 is a schematic diagram of a motor according to a second embodiment.

FIG. 5 is a circuit diagram showing a configuration in which a polyphase motor switching device is provided in the motor according to the second embodiment.

FIG. 6 is a schematic diagram of the motor according to the second embodiment, in which the reference numerals of coil parts are clearly indicated.

FIG. 7 is a graph representing the relationship between the torque and rotation speed of the motor according to the second embodiment.

FIG. 8 is a circuit diagram showing an example of connections between coil parts and switching units in another embodiment.

FIG. 9 is a circuit diagram showing an example of conventional connections between coil parts and switching units.

### DETAILED DESCRIPTION OF PREFERRED EMBODIMENTS

Hereinafter embodiments of the present disclosure will be listed and exemplified. Aspects one to seven exemplified below may be combined in any manner without causing any contradiction.

In a first aspect, a polyphase motor switching device of the present disclosure is used in a polyphase motor including polyphase coils, each of which has a plurality of coil parts. The polyphase motor switching device of the present disclosure includes a switching unit that changes the number of series connections of the plurality of coil parts in each of the coils.

According to this configuration, the characteristics of the polyphase motor can be changed in various ways by changing the number of series connections of the coil parts. The number of series connections here means the number of coil parts that are connected in series and can conduct electricity.

In a second aspect, in the polyphase motor switching device according to the first aspect, the switching unit has a plurality of relay switches, and is capable of changing the number of series connections by individually switching the relay switches between an on state and an off state.

The polyphase motor switching device according to the second aspect can have the switching unit simplified in structure by using the relay switches.

In a third aspect, in the polyphase motor switching device according to the second aspect, each of the coils may have a first coil part and a second coil part, one end of the first coil part may be connected to a first conductive path, and the other end of the second coil part may be connected to a second conductive path. The switching unit may have a first relay switch provided between the other end of the first coil part and the other end of the second coil part, and a second relay switch provided between the other end of the first coil part and one end of the second coil part. A non short-circuit configuration may always be established between the one end of the second coil part and the first conductive path.

In the polyphase motor switching device according to the third aspect, the number of series connections in the coil can be changed at only the first coil part or at the first and second coil parts by alternately switching the first relay switch and the second relay switch. A short circuit configuration here refers to a configuration in which, when current is passed between the one end of the second coil part and the first conductive path via the coil, and the non-short-circuit configuration here refers to a configuration that is not a short circuit configuration (that is, there is no path for current to pass without intervention of the coil).

In a fourth aspect, in the polyphase motor switching device according to the second aspect, the plurality of coil parts are connected in series, and the switching unit may be configured to connect one of both ends of the coil parts connected in series and all the coil parts to the first conductive path, and to connect the others to the second conductive path.

The polyphase motor switching device according to the fourth aspect can utilize a desired portion of the coil parts.

In a fifth aspect, in the polyphase motor switching device according to the first or the second aspect, the plurality of coil parts are arranged in an annular shape, and the coil parts placed outside a range of use by the switching unit may be dispersed in a circumferential direction.

The polyphase motor switching device according to the fifth aspect can disperse the influence of the coil parts that are outside the range of use in the circumferential direction. The coil parts in the range of use here refers to the coil parts through which current flows, and the coil parts outside the range of use refers to the coil parts through which no current flows.

In a sixth aspect, in the polyphase motor switching device according to the first or the second aspect, the plurality of coil parts are arranged in an annular shape, and the coil parts placed outside a range of use by the switching unit may be arranged more densely in the circumferential direction,

The polyphase motor switching device according to [6] can be expected to save space because the positions at which the coil parts are connected to the switching unit can be easily collected together in the circumferential direction.

In a seventh aspect, the polyphase motor switching device according to the first or the second aspect may further include a control device that controls operation of the switching unit.

The polyphase motor switching device according to [7] makes it easy for the control device to operate the switching unit favorably.

### First Embodiment

### Configuration of Motor

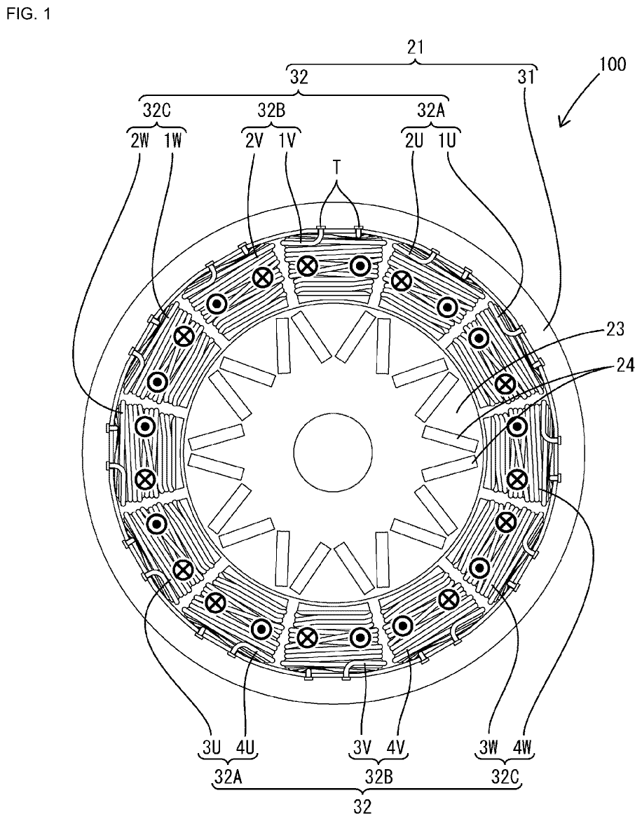

A polyphase motor switching device 10 according to a first embodiment is used for a motor 100, which is a polyphase motor that utilizes a polyphase alternating current power supply. As shown in FIG. 1, the motor 100 includes a stator unit 21 and a rotor unit 23.

### Configuration of Stator Unit

The stator unit 21 is stored in a housing (not shown). The stator unit 21 has a stator core 31 and a plurality of coils 32A, 32B, and 32C. For example, the stator core 31 is made of a conductive metal and has a cylindrical shape.

The plurality of coils 32A, 32B, and 32C are configured as three-phase segment coils. The coil 32A corresponds to the first phase (U phase), the coil 32B corresponds to the second phase (V phase), and the coil 32C corresponds to the third phase (W phase). The coil 32A of the first phase (U phase) has first coil parts 1U and 3U, which are coil parts, and second coil parts 2U and 4U, which are coil parts. The coil 32B of the second phase (V phase) has first coil parts 1V and 3V, which are coil parts, and second coil parts 2V and 4V, which are coil parts. The coil 32C of the third phase (V phase) has first coil parts 1W and 3W, which are coil parts, and second coil parts 2W and 4W, which are coil parts.

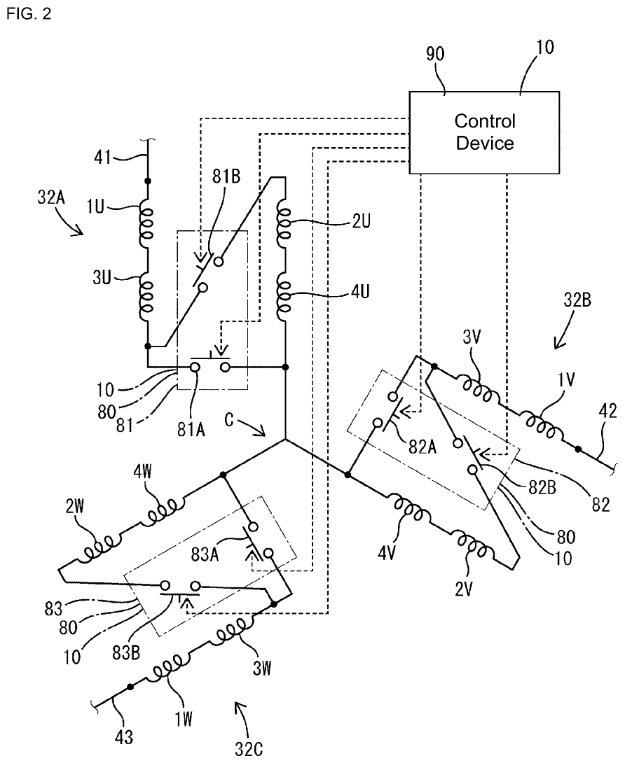

Each of the first coil parts 1U, BU, 1V, 3V, 1W, and 3W and the second coil parts 2U, 4U, 2V, 4V, 2W, and 4W is formed such that its own electric wire is wound in a spiral shape (coil shape). As shown in FIG. 2, the first coil parts 1U, 3U, 1V, 3V, 1W, and 3W and the second coil parts 2U, 4U, 2V, 4V, 2W, and 4W are electrically connected to each other so as to be radially continuous from a second conductive path C, which is a neutral part. For example, the second conductive path C is formed of a bus bar or the like.

In the present disclosure, the “electrically connected” configuration preferably means a configuration in which the connection targets are connected in a mutually conductive state (a state in which current can flow) so that the potentials of both connection targets are equal. However, the present disclosure is not limited to this configuration. For example, the “electrically connected” configuration may mean a configuration in which connection targets are connected in a mutually conductive state with an electric component interposed between them.

As shown in FIG. 1, the first coil parts 1U, 3U, 1V, 3V, 1W, 3W and the second coil parts 2U, 4U, 2V, 4V, 2W, 4W are arranged in an annular shape along the inner periphery of the stator core 31. Specifically, the first coil parts 1U, SU, 1V, 3V, 1W, and 3W and the second coil parts 2U, 4U, 2V, 4V, 2W, and 4W are arranged such that their axes orthogonal to the winding direction are oriented in the direction orthogonal to the central axis of the stator core 31.

Each of the first coil parts 1U, 3U, 1V, 3V, 1W, and 3W and the second coil parts 2U, 4U, 2V, 4V, 2W, and 4W has a pair of terminal portions T. The terminal portions T of the first coil parts 1U, BU, 1V, 3V, 1W, and 3W and the second coil parts 2U, 4U, 2V, 4V, 2W, and 4W arranged along the inner periphery of the stator core 31 are pulled out to one side in the axial direction of the stator core 31.

In FIG. 1, symbols with an x in a circle and symbols with a black circle in a circle correspond to pairs of terminal portions T in the first coil parts 1U, BU, 1V, 3V, 1W, and 3W and the second coil parts 2U, 4U, 2V, 4V, 2W, and 4W. The terminal portions corresponding to the symbols with an x in a circle are arranged on the outside (the side farther from the second conductive path C) in FIG. 2, and the terminal portions corresponding to the symbols with a black circle in a circle are arranged on the inside (the side closer to the second conductive path C) in FIG. 2.

As shown in FIG. 2, first conductive paths 41, 42, and 43 are electrically connected to the terminal portions of the first coil parts 1U, 1V, and 1W that are farthest from the second conductive path C. The first conductive paths 41, 42, and 43 are formed of bus bars, for example, and function as conductive paths that are interposed between an inverter (not shown) and the coils 32A, 32B, and 32C.

As shown in FIG. 1, the rotor unit 23 is rotatably arranged inside the stator unit 21. The rotor unit 23 has a plurality of permanent magnets 24 arranged on its outer peripheral edge.

Configuration of Polyphase Motor Switching Device As shown in FIG. 2, the polyphase motor switching device 10 has a switching unit 80 and a control device 90. The switching unit 80 has a first switching unit 81, a second switching unit 82, and a third switching unit 83. The first switching unit 81 changes the number of series connections in the first coil parts 1U and 3U and the second coil parts 2U and 4U constituting the first phase (U phase) coil. The second switching unit 82 changes the number of series connections in the first coil parts 1V and 3V and the second coil parts 2V and 4V constituting the second phase (V phase) coil. The third switching unit 83 changes the number of series connections in the first coil parts 1W and 3W and the second coil parts 2W and 4W constituting the third phase (W phase) coil.

The first switching unit 81 has a first relay switch 81A and a second relay switch 81B. The first relay switch 81A and the second relay switch 81B are configured as semiconductor relays. The semiconductor relays are formed of MOSFETs, GaNFETs, IGBTs, bipolar transistors, or the like, for example. The first relay switch 81A and the second relay switch 81B are switched between the on state and the off state in response to an on instruction or an off instruction by a control signal from the control device 90 described later. The first relay switch 81A and the second relay switch 81B are switched to the on state in which current is allowed to flow therethrough in response to the on instruction from the control device 90, and switched to the off state in which the flow of current therethrough is blocked in response to the off instruction from the control device 90.

The control device 90 is configured as an information processing device having a calculation function and an information processing function, for example. The control device 90 may be configured as a microcomputer, or may be configured as another type of information processing device.

The second switching unit 82 has a first relay switch 82A and a second relay switch 82B. The first relay switch 82A and the second relay switch 82B have the same configuration as that of the first relay switch 81A and the second relay switch 81B. The third switching unit 83 has a first relay switch 83A and a second relay switch 83B. The first relay switch 83A and the second relay switch 83B have the same configuration as that of the first relay switch 81A and the second relay switch 81B.

The first conductive path 41 is electrically connected to one end of the first coil part 1U. The other end of the first coil part 1U is electrically connected to one end of the first coil part 3U. The second conductive path C is electrically connected to the other end of the second coil part 4U. One end of the second coil part 4U is electrically connected to the other end of the second coil part 2U. The first relay switch 81A is provided between the other end of the first coil part 3U and the other end of the second coil part 4U. The second relay switch 81B is provided between the other end of the first coil part 3U and one end of the second coil part 2U. The second coil parts 2U and 4U are not connected to the one end of the first coil part 1U and the first conductive path 41. In other words, a non-short-circuit configuration is always established between the second coil parts 2U and 4U and the first conductive path 41.

The control device 90 changes the number of series connections in the coil 32A that form a path for conducting electricity between the first conductive path 41 and the second conductive path C by providing the off instruction to either the first relay switch 81A or the second relay switch 81B and the on instruction to the other. Specifically, when the control device 90 provides the on instruction to the first relay switch 81A and the off instruction to the second relay switch 81B, then the first conductive path 41, the first coil parts 1U and 3U, and the second conductive path C are electrically connected in series in this order. Accordingly, the first coil parts 1U and 3U are placed in the range of use and current flows through them. On the other hand, the second coil parts 2U and 4U are placed outside the range of use and no current flows through them. At this time, the number of series connections in the coil 32A is two.

When the control device 90 provides the off instruction to the first relay switch 81A and the on instruction to the second relay switch 81B, the first conductive path 41, the first coil parts 1U and 3U, the second coil parts 2U and 4U, and the second conductive path C are electrically connected in series in this order. Accordingly, the first coil parts 1U and 3U and the second coil parts 2U and 4U are placed in the range of use, and current flows through them. At this time, the number of series connections in the coil 32A is four.

The first conductive path 42 is electrically connected to one end of the first coil part 1V. The other end of the first coil part 1V is electrically connected to one end of the first coil part 3V. The second conductive path C is electrically connected to the other end of the second coil part 4V. One end of the second coil part 4V is electrically connected to the other end of the second coil part 2V. The first relay switch 82A is provided between the other end of the first coil part 3V and the other end of the second coil part 4V. The second relay switch 82B is provided between the other end of the first coil part 3V and one end of the second coil part 2V. The second coil parts 2V and 4V are not connected to the one end of the first coil part 1V and the first conductive path 42. In other words, a non-short-circuit configuration is always established between the second coil parts 2V and 4V and the first conductive path 42.

The control device 90 changes the number of series connections in the coil 32B that form a path for conducting electricity between the first conductive path 42 and the second conductive path C by providing the off instruction to either the first relay switch 82A or the second relay switch 82B and the on instruction to the other. Specifically, when the control device 90 provides the on instruction to the first relay switch 82A and the off instruction to the second relay switch 82B, the first conductive path 42, the first coil parts 1V and 3V, and the second conductive path C are electrically connected in series in this order. Accordingly, the first coil parts 1V and 3V are placed in the range of use, and current flows through them. On the other hand, the second coil parts 2V and 4V are placed outside the range of use, and no current flows through them. At this time, the number of series connections in the coil 32B is two.

When the control device 90 provides the off instruction to the first relay switch 82A and the on instruction to the second relay switch 82B, the first conductive path 42, the first coil parts 1V and 3V, the second coil parts 2V and 4V, and the second conductive path C are electrically connected in series in this order. Accordingly, the first coil parts 1V and 3V and the second coil parts 2V and 4V are placed in the range of use, and current flows through them. At this time, the number of series connections in the coil 32B is four.

The first conductive path 43 is electrically connected to one end of the first coil part 1W. The other end of the first coil part 1W is electrically connected to one end of the first coil part 3W. The second conductive path C is electrically connected to the other end of the second coil part 4W. One end of the second coil part 4W is electrically connected to the other end of the second coil part 2W. The first relay switch 83A is provided between the other end of the first coil part 3W and the other end of the second coil part 4W. The second relay switch 83B is provided between the other end of the first coil part 3W and one end of the second coil part 2W. The second coil parts 2W and 4W are not connected to the one end of the first coil part 1W and the first conductive path 43. In other words, a non-short-circuit configuration is always established between the second coil parts 2W and 4W and the first conductive path 43.

The control device 90 changes the number of series connections in the coil 32C that forms a path for conducting electricity between the first conductive path 43 and the second conductive path C by providing the off instruction to either the first relay switch 83A or the second relay switch 83B and the on instruction to the other. Specifically, when the control device 90 provides the on instruction to the first relay switch 83A and the off instruction to the second relay switch 83B, the first conductive path 43, the first coil parts 1W and 3W, and the second conductive path C are electrically connected in series in this order. Accordingly, the first coil parts 1W and 3W are placed in the range of use, and current flows through them. On the other hand, the second coil parts 2W and 4W are placed outside the range of use and no current flows through them. At this time, the number of series connections in the coil 32C is two.

When the control device 90 provides the off instruction to the first relay switch 83A and the on instruction to the second relay switch 83B, the first conductive path 43, the first coil parts 1W and 3W, the second coil parts 2W and 4W, and the second conductive path C are electrically connected in series in this order. Accordingly, the first coil parts 1W and 3W and the second coil parts 2W and 4W are placed in the range of use, and current flows through them. At this time, the number of series connections in the coil 32C is four.

In this manner, the polyphase motor switching device 10 changes the number of series connections in the plurality of coil parts (first coil parts 1U, 3U, 1V, 3V, 1W, and 3W and second coil parts 2U, 4U, 2V, 4V, 2W, and 4W) that constitute the coils 32A, 32B, and 32C.

### Coil Parts Outside Range of Use

When the control device 90 provides the on instruction to the first relay switches 81A, 82A, and 83A and the off instruction to the second relay switches 81B, 82B, and 83B, the second coil parts 2U, 4U, 2V, 4V, 2W, and 4W are placed outside the range of use. In this case, the second coil parts 2U, 4U, 2V, 4V, 2W, and 4W, which are placed outside the range of use by the switching unit 80, are dispersed in the circumferential direction (see FIG. 1). The first coil parts 1U, 3U, 1V, 3V, 1W, and 3W in the range of use are also dispersed in the circumferential direction. Specifically, the second coil parts 2U, 4U, 2V, 4V, 2W, and 4W are evenly spaced apart in the circumferential direction. The first coil parts 1U, 3U, 1V, 3V, 1W, and 3W are also evenly spaced apart in the circumferential direction. The first coil parts 1U, BU, 1V, 3V, 1W, and 3W in the range of use and the second coil parts 2U, 4U, 2V, 4V, 2W, and 4W outside the range of use are arranged alternately in the circumferential direction.

### Motor Torque and Rotation Speed Characteristics

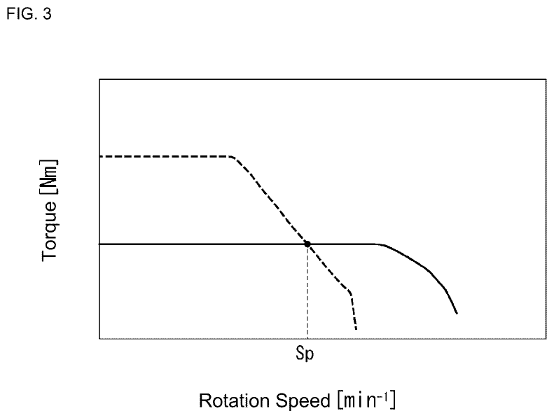

The control device 90 provides the on instruction to the first relay switches 81A, 82A, and 83A, and the off instruction to the second relay switches 81B, 82B, and 83B. Accordingly, current flows through the first coil parts 1U, 3U, 1V, 3V, 1W, and 3W that are placed in the range of use, and no current flows through the second coil parts 2U, 4U, 2V, 4V, 2W, and 4W that are placed outside the range of use. In this case, the relationship between the torque and rotation speed of the motor 100 changes along with the characteristic of the solid line shown in FIG. 3.

The control device 90 provides the off instruction to the first relay switches 81A, 82A, and 83A, and the on instruction to the second relay switches 81B, 82B, and 83B. Accordingly, current flows through the first coil parts 1U, 3U, 1V, 3V, 1W, and 3W and the second coil parts 2U, 4U, 2V, 4V, 2W, and 4W in the range of use. In this case, the relationship between the torque and rotation speed of the motor 100 changes along with the characteristic of the dotted line shown in FIG. 3. Referring to FIG. 3, in both the solid-line characteristics and the dotted-line characteristics, the torque has a constant value in a region where the rotation speed is relatively low. Then, when the rotation speed exceeds a certain value, the torque decreases.

Comparing the solid-line characteristics and the dotted-line characteristics, the magnitude of the torque in the region where the torque has a constant value is greater in the dotted-line characteristics. The range of rotation speed in the solid-line characteristics is wider than that in the dotted-line characteristics, and extends to the high rotation side. Therefore, in a predetermined low rotation speed state, the off instruction is provided to the first relay switches 81A, 82A, and 83A, and the on instruction is provided to the second relay switches 81B, 82B, and 83B so as to obtain the dotted-line characteristics. Accordingly, the first coil parts 1U, 3U, 1V, 3V, 1W, and 3W and the second coil parts 2U, 4U, 2V, 4V, 2W, and 4W are placed in the range of use.

In a higher rotation speed state than the predetermined low rotation speed state, the on instruction is provided to the first relay switches 81A, 82A, and 83A, and the off instruction is provided to the second relay switches 81B, 82B, and 83B so as to obtain the solid-line characteristics. Accordingly, the first coil parts 1U, 3U, 1V, 3V, 1W, and 3W are placed in the range of use. The predetermined low rotation speed state is a state in which the rotation speed of the motor 100 is or lower than or equal to a predetermined threshold value, for example. In this state, the rotation speed may be lower than or equal to a point Sp in FIG. 3, for example. Moreover, in the higher rotation speed state than the predetermined low rotation speed state, the rotation speed may be higher than the point Sp in FIG. 3.

Next, the advantageous effects of this configuration will be exemplified.

The polyphase motor switching device 10 is used for the motor 100 having the plurality of phase coils 32A, 32B, and 32C, each of which has the first coil parts 1U, 3U, 1V, 3V, 1W, and 3W and the second coil parts 2U, 4U, 2V, 4V, 2W, and 4W. The polyphase motor switching device 10 of the present disclosure includes the switching unit 80 that changes the number of series connections of the first coil parts 1U, 3U, 1V, 3V, 1W, and 3W and the second coil parts 2U, 4U, 2V, 4V, 2W, and 4W in the coils 32A, 32B, and 32C. According to this configuration, the characteristics of the motor 100 can be changed in various ways by switching the number of series connections of the first coil parts 1U, 3U, 1V, 3V, 1W, and SW and the second coil parts 2U, 4U, 2V, 4V, 2W, and 4W. The number of series connections here means the number of first coil parts 1U, 3U, 1V, 3V, 1W, and 3W and second coil parts 2U, 4U, 2V, 4V, 2W, and 4W that are connected in series and are capable of conducting electricity.

In the polyphase motor switching device 10, the switching unit 80 has the first relay switches 81A, 82A, and 83A and the second relay switches 81B, 82B, and 83B. The switching unit 80 changes the number of series connections by individually switching among the first relay switches 81A, 82A, and 83A and the second relay switches 81B, 82B, and 83B between the on state and the off state, According to this configuration, the switching unit 80 can be simplified in structure by using the relay switches.

In the polyphase motor switching device 10, the coils 32A, 32B, and 32C have the first coil parts 1U, 3U, 1V, 3V, 1W, and 3W and the second coil parts 2U, 4U, 2V, 4V, 2W, and 4W. One-side ends of the first coil part 1U, 1V, and 1W are connected to the first conductive paths 41, 42, and 43, and the other ends of the second coil parts 4U, 4V, and 4W are connected to the second conductive path C. The switching unit 80 has the first relay switches 81A, 82A, and 83A and the second relay switches 81B, 82B, and 83B. The first relay switches 81A, 82A, and 83A are provided between the other ends of the first coils part 3U, 3V, and 3W and the other ends of the second coil part 4U, 4V, and 4W. The second relay switches 81B, 82B, and 83B are provided between the other ends of the first coil parts 3U, 3V, and 3W and one-side ends of the second coil parts 2U, 2V, and 2W. A non-short circuit configuration is always established between one-side ends of the second coil parts 2U, 2V, and 2W and the first conductive paths 41, 42, and 43. According to this configuration, the number of series connections in the coils 32A, 32B, and 32C can be changed to only the first coil parts 1U, BU, 1V, 3V, 1W, and 3W or to the first coil parts 1U, 3U, 1V, 3V, 1W, and 3W and the second coil parts 2U, 4U, 2V, 4V, 2W, and 4W, by alternately switching between the first relay switches 81A, 82A, and 83A and the second relay switches 81B, 82B, and 83B.

The short-circuit configuration here is a configuration in which electricity is always passed between one side ends of the second coil part 2U, 2V, and 2W and the first conductive path 41, 42, and 43 via the coil 32A, 32B, and 32C. The non-short-circuit configuration here is a configuration that is not the short-circuit configuration (that is, there is no path for electricity to pass without intervention of the coil 32A, 32B, and 32C).

In the polyphase motor switching device 10, the first coil parts 1U, 3U, 1V, 3V, 1W, and 3W and the second coil parts 2U, 4U, 2V, 4V, 2W, and 4W are arranged in an annular shape. The second coil parts 2U, 4U, 2V, 4V, 2W, and 4W, which are placed outside the range of use by the switching part 80, are dispersed in the circumferential direction. According to this configuration, the influence of the second coil parts 2U, 4U, 2V, 4V, 2W, and 4W outside the range of use can be dispersed in the circumferential direction. The coil parts in the range of use here refer to the coil parts out of the first coil parts 1U, 3U, 1V, 3V, 1W, and 3W and the second coil parts 2U, 4U, 2V, 4V, 2W, and 4W, through which current flows, and the coil parts outside the range of use here refer to the coil parts through which no current flows.

The polyphase motor switching device 10 further includes the control device 90 that controls the operation of the switching unit 80. According to this configuration, the control device 90 can easily cause the switching unit 80 to operate favorably.

### Second Embodiment

A polyphase motor switching device 110 in a second embodiment differs from the first embodiment in the configuration of connection between a switching unit 180 and coils 132A, 132B, and 132C, and in the method of switching between relay switches by the switching unit 180. In addition, a motor 200 in the second embodiment differs from the first embodiment in the configuration of the coils 132A, 132B, and 132C. Detailed description of the same components as those of the first embodiment will be omitted.

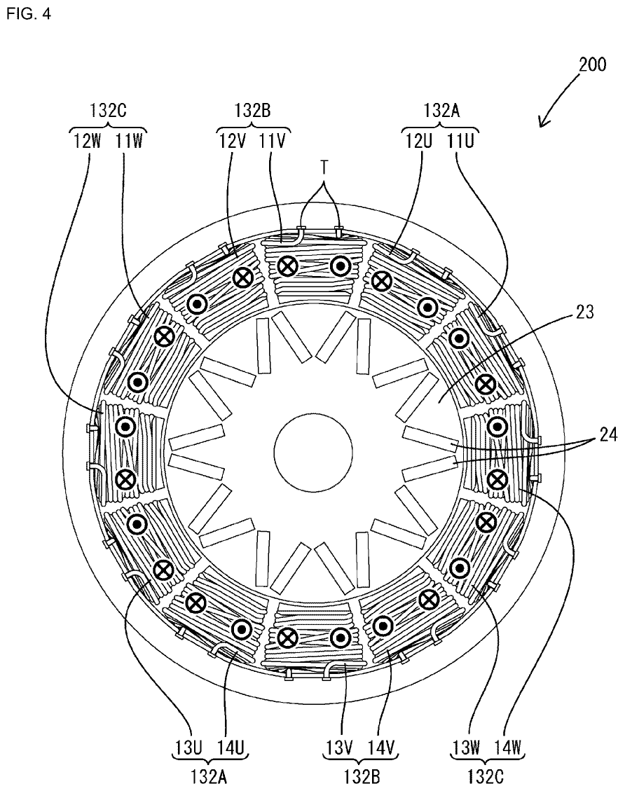

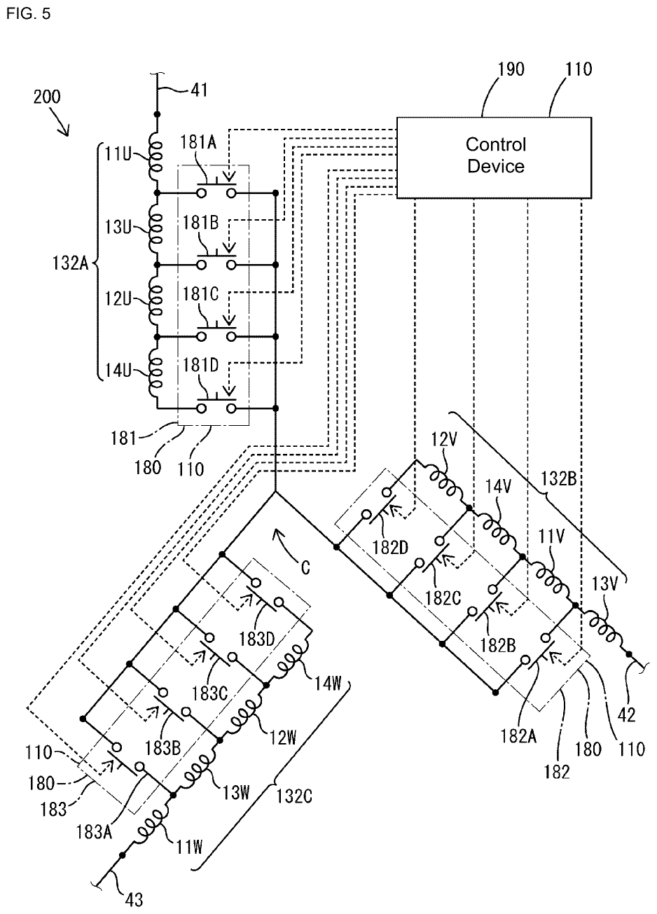

As shown in FIG. 4, the motor 200 of the second embodiment has the coils 132A, 132B, and 132C. As shown in FIG. 5, the coil 132A has coil parts 11U, 13U, 12U, and 14U connected in series in this order. One end of the coil part 11U is electrically connected to a first conductive path 41.

The coil 132B has a configuration in which coil parts 13V, 11V, 14V, and 12V are connected in series in this order, One end of the coil part 13V is electrically connected to a first conductive path 42. The coil 132C has a configuration in which coil parts 11W, 13W, 12W, and 14W are connected in series in this order. One end of the coil part 11W is electrically connected to a first conductive path 43.

### Configuration of Polyphase Motor Switching Device

The polyphase motor switching device 110 has the switching unit 180 and a control device 190. The switching unit 180 includes a first switching unit 181, a second switching unit 182, and a third switching unit 183. The first switching unit 181 changes the number of series connections that form a path for conducting electricity between the first conductive path 41 and a second conductive path C among the coil parts 11U, 13U, 12U, and 14U that constitute the coil of the first phase (U phase), The second switching unit 182 changes the number of series connections that form a path for conducting electricity between the first conductive path 41 and the second conductive path C among the coil parts 13V, 11V, 14V, and 12V that constitute the coil of the second phase (V phase). The third switching unit 183 changes the number of series connections that form a path for conducting electricity between the first conductive path 41 and the second conductive path C among the coil parts 11W, 13W, 12W, and 14W that constitute the coil of the third phase (W phase).

The first switching unit 181 has a first relay switch 181A, a second relay switch 181B, a third relay switch 181C, and a fourth relay switch 181D. The first relay switch 181A, the second relay switch 181B, the third relay switch 181C, and the fourth relay switch 181D are configured as semiconductor relays. The semiconductor relays are constituted of MOSFETs, GaNFETs, IGBTs, bipolar transistors, or the like, for example.

The first relay switch 181A, the second relay switch 181B, the third relay switch 181C, and the fourth relay switch 181D are switched between an on operation and an off operation by a control signal from the control device 190 described later, The first relay switch 181A, the second relay switch 181B, the third relay switch 181C, and the fourth relay switch 181D are switched to the on state in which current is permitted to flow through them by the on instruction from the control device 190. The first relay switch 181A, the second relay switch 181B, the third relay switch 181C, and the fourth relay switch 181D are switched to the off state in which a flow of current through them is shut off by the off instruction from the control device 190.

The control device 190 is configured as an information processing device having a calculation function and an information processing function, for example. The control device 190 may be configured as a microcomputer, or may be configured as another type of information processing device.

The second switching unit 182 has a first relay switch 182A, a second relay switch 182B, a third relay switch 182C, and a fourth relay switch 182D. The first relay switch 182A, the second relay switch 182B, the third relay switch 182C, and the fourth relay switch 182D have the same configuration as the first relay switch 181A, the second relay switch 181B, the third relay switch 181C, and the fourth relay switch 181D.

The third switching unit 183 has a first relay switch 183A, a second relay switch 183B, a third relay switch 183C, and a fourth relay switch 183D. The first relay switch 183A, the second relay switch 183B, the third relay switch 183C, and the fourth relay switch 183D have the same configuration as the first relay switch 181A, the second relay switch 181B, the third relay switch 181C, and the fourth relay switch 181D.

One end of the first relay switch 181A is electrically connected to the connection point between the other end of the coil part 11U and one end of the coil part 13U. The other end of the first relay switch 181A is electrically connected to the second conductive path C. One end of the second relay switch 181B is electrically connected to the connection point between the other end of the coil part 18U and one end of the coil part 12U. The other end of the second relay switch 181B is electrically connected to the second conductive path C. One end of the third relay switch 181C is electrically connected to the connection point between the other end of the coil part 12U and one end of the coil part 14U. The other end of the third relay switch 181C is electrically connected to the second conductive path C. One end of the fourth relay switch 181D is electrically connected to the other end of the coil part 14U. The other end of the fourth relay switch 181D is electrically connected to the second conductive path C.

One end of the first relay switch 182A is electrically connected to the connection point between the other end of the coil part 13V and one end of the coil part 11V. The other end of the first relay switch 182A is electrically connected to the second conductive path C. One end of the second relay switch 182B is electrically connected to the connection point between the other end of the coil part 11V and one end of the coil part 14V. The other end of the second relay switch 182B is electrically connected to the second conductive path C. One end of the third relay switch 182C is electrically connected to the connection point between the other end of the coil part 14V and one end of the coil part 12V. The other end of the third relay switch 182C is electrically connected to the second conductive path C. One end of the fourth relay switch 182D is electrically connected to the other end of the coil part 12V. The other end of the fourth relay switch 182D is electrically connected to the second conductive path C.

One end of the first relay switch 183A is electrically connected to the connection point between the other end of the coil part 11W and one end of the coil part 13W. The other end of the first relay switch 183A is electrically connected to the second conductive path C. One end of the second relay switch 183B is electrically connected to the connection point between the other end of the coil part 13W and one end of the coil part 12W. The other end of the second relay switch 183B is electrically connected to the second conductive path C. One end of the third relay switch 183C is electrically connected to the connection point between the other end of the coil part 12W and one end of the coil part 14W. The other end of the third relay switch 183C is electrically connected to the second conductive path C. One end of the fourth relay switch 183D is electrically connected to the other end of the coil part 14W. The other end of the fourth relay switch 183D is electrically connected to the second conductive path C.

The control device 190 changes the number of series connections in the coil 132A by providing the on instruction to one of the first relay switch 181A, the second relay switch 181B, the third relay switch 181C, and the fourth relay switch 181D and the off instruction to the others. Specifically, the control device 190 provides the on instruction to the first relay switch 181A and the off instruction to the others. Then, the first conductive path 41, the coil part 11U, and the second conductive path C are electrically connected in series in this order. Accordingly, the coil part 11U is placed in the range of use, and current flows through it. On the other hand, the coil parts 13U, 12U, and 14U are placed outside the range of use, and no current flows through them. At this time, the number of series connection in the coil 132A is one.

The control device 190 provides the on instruction to the second relay switch 181B and the off instruction to the others. Then, the first conductive path 41, the coil parts 11U and 13U, and the second conductive path C are electrically connected in series in this order. Accordingly, the coil parts 11U and 13U are placed in the range of use, and current flows through them. On the other hand, the coil parts 12U and 14U are placed outside the range of use, and no current flows through them. At this time, the number of series connections in the coil 132A is two.

The control device 190 provides the on instruction to the third relay switch 181C and the off instruction to the others. Then, the first conductive path 41, the coil parts 11U, 13U, and 12U, and the second conductive path C are electrically connected in series in this order. Accordingly, the coil parts 11U, 13U, and 12U are placed in the range of use, and current flows through them. On the other hand, the coil part 14U is placed outside the range of use, and no current flows through it. At this time, the number of series connections in the coil 132A is three.

The control device 190 provides the on instruction to the fourth relay switch 181D and the off instruction to the others. Then, the first conductive path 41, the coil parts 11U, 13U, 12U, and 14U, and the second conductive path C are electrically connected in series in this order. Accordingly, the coil parts 11U, 13U, 12U, and 14U are placed in the range of use, and current flows through them. At this time, the number of series connections in the coil 132A is four. In this way, the control device 190 changes the number of series connections of the coil parts 11U, 13U, 12U, and 14U by individually switching among the first relay switch 181A, the second relay switch 181B, the third relay switch 181C, and the fourth relay switch 181D.

The control device 190 changes the range of use of the coil 132B by providing the on instruction to one of the first relay switch 182A, the second relay switch 182B, the third relay switch 182C, and the fourth relay switch 182D and the off instruction to the others. Specifically, the control device 190 provides the on instruction to the first relay switch 182A and the off instruction to the others. Then, the first conductive path 42, the coil part 18V, and the second conductive path C are electrically connected in series in this order. Accordingly, the coil part 13V is placed in the range of use, and current flows through it. On the other hand, the coil parts 11V, 14V, and 12V are placed outside the range of use, and no current flows through them. At this time, the number of series connection in the coil 132B is one.

The control device 190 provides the on instruction to the second relay switch 182B and the off instruction to the others. Then, the first conductive path 42, the coil parts 13V and 11V, and the second conductive path C are electrically connected in series in this order. Accordingly, the coil parts 13V and 11V are placed in the range of use, and current flows through them. On the other hand, the coil parts 14V and 12V are placed outside the range of use, and no current flows through them. At this time, the number of series connections in the coil 132B is two.

The control device 190 provides the on instruction to the third relay switch 182C and the off instruction to the others. Then, the first conductive path 42, the coil parts 13V, 11V, and 14V, and the second conductive path C are electrically connected in series in this order. Accordingly, the coil parts 13V, 11V, and 14V are placed in the range of use, and current flows through them. On the other hand, the coil part 12V is placed outside the range of use, and no current flows through it. At this time, the number of series connections in the coil 132B is three.

The control device 190 provides the on instruction to the fourth relay switch 182D and the off instruction to the others. Then, the first conductive path 42, the coil parts 13V, 11V, 14V, and 12V, and the second conductive path C are electrically connected in series in this order. Accordingly, the coil parts 13V, 11V, 14V, and 12V are placed in the range of use, and current flows through them. At this time, the number of series connections in the coil 132B is four.

The control device 190 changes the range of use of the coil 132C by providing the on instruction to one of the first relay switch 183A, the second relay switch 183B, the third relay switch 183C, and the fourth relay switch 183D and the off instruction to the others. Specifically, the control device 190 provides the on instruction to the first relay switch 183A and the off instruction to the others. Then, the first conductive path 43, the coil part 11W, and the second conductive path C are electrically connected in series in this order. Accordingly, the coil part 11W is placed in the range of use, and current flows through it. On the other hand, the coil parts 13W, 12W, and 14W are placed outside the range of use, and no current flows through them. At this time, the number of series connection in the coil 132C is one.

The control device 190 provides the on instruction to the second relay switch 183B and the off instruction to the others. Then, the first conductive path 43, the coil parts 11W and 13W, and the second conductive path C are electrically connected in series in this order. Accordingly, the coil parts 11W and 13W are placed in the range of use, and current flows through them. On the other hand, the coil parts 12W and 14W are placed outside the range of use, and no current flows through them. At this time, the number of series connections in the coil 132C is two.

The control device 190 provides the on instruction to the third relay switch 183C and the off instruction to the others. Then, the first conductive path 48, the coil parts 11W, 13W, and 12W, and the second conductive path C are electrically connected in series in this order. Accordingly, the coil parts 11W, 13W, and 12W are placed in the range of use, and current flows through them. On the other hand, the coil part 14W is placed outside the range of use, and no current flows through it. At this time, the number of series connections in the coil 132C is three.

The control device 190 provides the on instruction to the fourth relay switch 183D and the off instruction to the others. Then, the first conductive path 43, the coil parts 11W, 13W, 12W, and 14W, and the second conductive path Care electrically connected in series in this order. Accordingly, the coil parts 11W, 13W, 12W, and 14W are placed in the range of use, and current flows through them. At this time, the number of series connections in the coil 132C is four.

In this way, the polyphase motor switching device 110 changes the number of series connections in each of the coils 132A, 132B, and 132C.

Coil Parts outside Range of Use

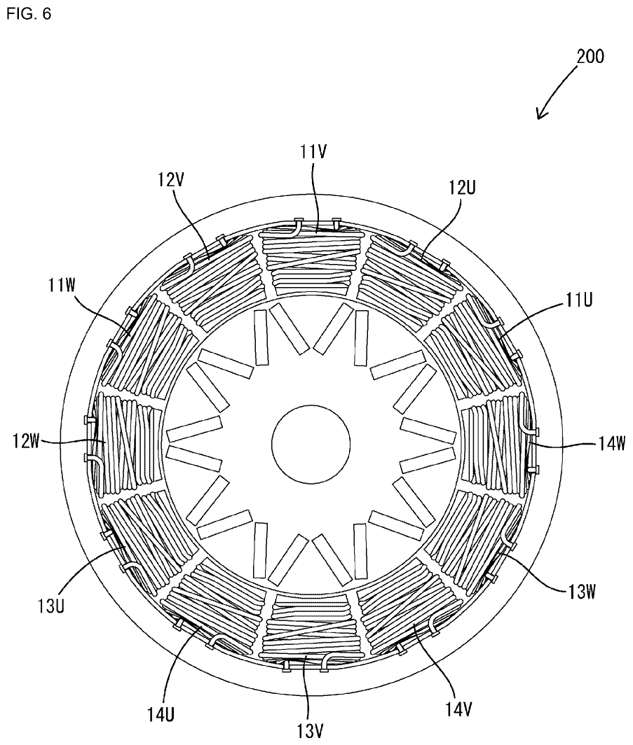

When the control device 190 provides the on instruction to the first relay switches 181A, 182A, and 183A and the off instruction to the other relay switches, the coil parts 13U, 12U, 14U, 11V, 14V, 12V, 13W, 12W, and 14W are placed outside the range of use. In this case, the coil parts 11U, 13V, and 11W placed in the range of use by the switching unit 180 are dispersed in the circumferential direction. Specifically, the coil parts 11U, 13V, and 11W are arranged so as to be evenly spaced apart in the circumferential direction (see FIG. 6).

When the control device 190 provides the on instruction to the second relay switches 181B, 182B, and 183B and provides the off instruction to the other relay switches, the coil parts 12U, 14U, 14V, 12V, 12W, and 14W are placed outside the range of use. In this case, the coil parts 12U, 14U, 14V, 12V, 12W, and 14W placed outside the range of use by the switching unit 180 are dispersed in the circumferential direction (see FIG. 6). In addition, the coil parts 11U, 13U, 13V, 11V, 11W, and 13W in the range of use are also dispersed in the circumferential direction (see FIG. 6). Specifically, the coil parts 12U, 14U, 14V, 12V, 12W, and 14W are evenly spaced apart in the circumferential direction. The coil parts 11U, 13U, 13V, 11V, 11W, and 13W are also evenly spaced apart in the circumferential direction.

When the control device 190 provides the on instruction to the third relay switches 181C, 182C, and 183C and the off instruction to the other relay switches, the coil parts 14U, 12V, and 14W are placed outside the range of use. In this case, the coil parts 14U, 12V, and 14W placed outside the range of use by the switching unit 180 are dispersed in the circumferential direction (see FIG. 6). Specifically, the coil parts 14U, 12V, and 14W are evenly spaced apart in the circumferential direction.

When the control device 190 provides the on instruction to the fourth relay switches 181D, 182D, and 183D and provides the off instruction to the other relay switches, the coil parts 11U, 13U, 12U, 14U, 13V, 11V, 14V, 12V, 11W, 13W, 12W, and 14W are not placed outside the range of use.

### Characteristics of Motor Torque and Rotation Speed

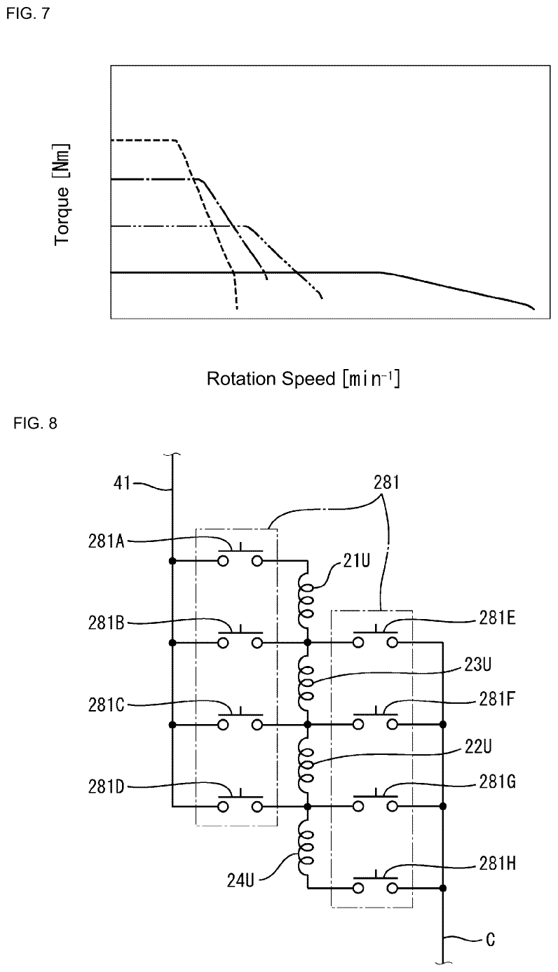

When the coil parts 11U, 13V, and 11W are placed in the range of use by the switching unit 180, current flows through the coil parts 11U, 13V, and 11W. In contrast, the coil parts 13U, 12U, 14U, 11V, 14V, 12V, 13W, 12W, and 14W are placed outside the range of use, and no current flows through them. In this case, the relationship between the torque and rotation speed of the motor 200 changes along with the characteristic of the solid line shown in FIG. 7.

When the coil parts 11U, 13U, 13V, 11V, 11W, and 13W are placed in the range of use by the switching unit 180, current flows through the coil parts 11U, 13U, 13V, 11V, 11W, and 18W. In contrast, the coil parts 12U, 14U, 14V, 12V, 12W, and 14W are placed outside the range of use, and no current flows through them. In this case, the relationship between the torque and rotation speed of the motor 200 changes along with the characteristic of the two-dot chain-line shown in FIG. 7.

When the coil parts 11U, 13U, 12U, 13V, 11V, 14V, 11W, 13W, and 12W are placed in the range of use by the switching unit 180, current flows through the coil parts 11U, 18U, 12U, 13V, 11V, 14V, 11W, 13W, and 12W. In contrast, the coil parts 14U, 12V, and 14W are placed outside the range of use, and no current flows through them. In this case, the relationship between the torque and rotation speed of the motor 200 changes along with the characteristic of the one dot chain-line shown in FIG. 7.

Current flows through the coil parts 11U, 18U, 12U, 14U, 13V, 11V, 14V, 12V, 11W, 13W, 12W, and 14W placed in the range of use by the switching unit 180. In this case, the relationship between the torque and rotation speed of the motor 200 changes along with the characteristic of the dotted line shown in FIG. 7.

In each of the characteristics shown in FIG. 7, the torque has a constant value in a region where the rotation speed is relatively low, Then, when the rotation speed exceeds a certain value, the torque decreases.

Comparing the characteristics, the magnitude of the torque in the region where the torque has a constant value is the largest in the dotted-line characteristic, followed by the one-dot chain line characteristic, then the two-dot chain-line characteristic, and the solid-line characteristic in which the torque is the smallest. Focusing on the range of rotation speed, the solid-line characteristic has the widest range extending toward the high rotation speed side, followed by the two-dot chain-line characteristic that has the second widest range extending toward the high rotation speed side, then the one dot chain-line characteristic that has the third widest range extending toward the high rotation speed side, and the dotted-line characteristic that has the narrowest range.

In the polyphase motor switching device 110, the coil parts 11U, 13U, 12U, and 14U are connected in series, the coil parts 18V, 11V, 14V, and 12V are connected in series, and the coil parts 11W, 13W, 12W, and 14W are connected in series. The switching unit 180 connects both ends of the coil parts 11U, 13U, 12U, and 14U, the coil parts 13V, 11V, 14V, and 12V, and the coil parts 11W, 13W, 12W, and 14W connected in series and one of the coil parts 11U, 13U, 12U, 14U, 13V, 11V, 14V, 12V, 11W, 13W, 12W, and 14W connected in series, to the first conductive paths 41, 42, and 43. At the same time, the switching unit 180 connects the others to the second conductive path C. According to this configuration, desired portions of the coil parts 11U, 13U, 12U, 14U, coil parts 13V, 11V, 14V, 12V, and the coil parts 11W, 13W, 12W, 14W can be used.

### Other Embodiments

The embodiments disclosed herein should be considered as illustrative and not restrictive in all respects. The scope of the present disclosure is not limited to the embodiments disclosed herein, but is indicated by the scope of the claims, and is intended to include all modifications within a meaning and scope equivalent to the scope of the claims.

Unlike the first embodiment, mechanical relays may be used as the relay switches.

The numbers of turns in coil parts may be the same or different. The number of coil parts in each phase may be greater than or less than four,

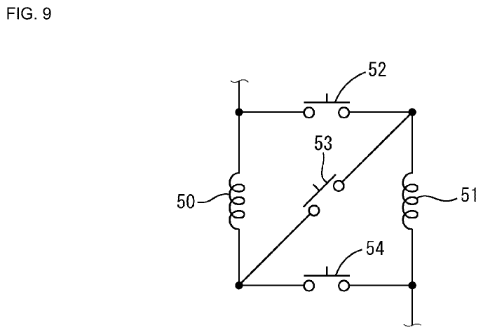

Unlike in the first embodiment, the configuration of each coil may be as shown in FIG. 9, and one end of a coil part 50 and one end of a coil part 51 may be connected by a relay switch 52. The relay switch 52 may always be in the off state, and a relay switch 53 and a relay switch 54 may be switched between the on and off states complementarily to change the range of use. The coil part 50 and the coil part 51 can be connected in parallel by turning on the relay switch 52 and the relay switch 54 and turning off the relay switch 53. The coil part 50 and the coil part 51 can be connected in series by turning off the relay switch 52 and the relay switch 54 and turning on the relay switch 53. That is, according to this configuration, two (even-number) coil parts 50 and 51 can be connected in series, half the number of series (one unit) can be connected in parallel, or only half the number of series (one unit) can be placed in the range of use.

Unlike in the second embodiment, the other ends of coil parts connected in series may be connected to a second conductive path, and the other end of each relay switch may be connected to a first conductive path.

As shown in FIG. 8, relay switches 281A, 281B, 281C, 281D, 281E, 281F, 281G, and 281H of a switching unit 281 may be connected to a plurality of coil parts 21U, 23U, 22U, and 24U connected in series. In this case, by turning on only one of the switches 281A, 281B, 281C, and 281D and turning on only one of the switches 281E, 281F, 281G, and 281H, it is possible to connect both ends of the coil parts 21U, 23U, 22U, and 24U connected in series and one of all the coil parts 21U, 23U, 22U, and 24U to the first conductive path 41 and connect the others to the second conductive path C. Accordingly, the desired portions of the coil parts 21U, 23U, 22U, and 24U can be used. In addition, when the directly connected relay switches 281A, 281B, 281C, 281D and 281E, 281F, 281G, and 281H are turned on, a first conductive path 41 and a second conductive path C are electrically connected without intervention of the coil parts 21U, 23U, 22U, and 24U. FIG. 8 shows an example of the U phase, and it is preferable that the V phase and the W phase have similar configurations.

Unlike in the second embodiment, coil parts may be connected such that coil parts 11U, 12U, 11V, 12V, 11W, and 12W are placed in the range of use and coil parts 13U, 14U, 13V, 14V, 13W, and 14W are placed outside the range of use (see FIG. 6). In other words, the coil parts 13U, 14U, 13V, 14V, 13W, and 14W placed outside the range of use by a switching unit may be arranged densely in the circumferential direction. In this case, the connections of switching units to coils can be easily collected in a portion in the circumferential direction, and space saving can be expected.

1. A polyphase motor switching device used in a polyphase motor including polyphase coils, each of which has a plurality of coil parts,
wherein the polyphase motor switching device comprises a switching unit that changes the number of series connections of the plurality of coil parts in each of the coils,
the plurality of coil parts are arranged in an annular shape, and
a pair of the coil parts placed outside a range of use in the coil of one phase are arranged at opposite positions across a central axis of the plurality of coil parts arranged in an annular shape.

2. The polyphase motor switching device according to claim 1, wherein the switching unit has a plurality of relay switches, and changes the number of series connections by individually switching the relay switches between an on state and an off state.

3. The polyphase motor switching device according to claim 2,
wherein each of the coils has a first coil part and a second coil part,
one end of the first coil part is connected to a first conductive path,
the other end of the second coil part is connected to a second conductive path,
the switching unit has a first relay switch provided between the other end of the first coil part and the other end of the second coil part, and a second relay switch provided between the other end of the first coil part and one end of the second coil part, and
a non-short-circuit configuration is always established between the one end of the second coil part and the first conductive path.

4. The polyphase motor switching device according to claim 2,
wherein the plurality of coil parts are connected in series, and
the switching unit is configured to connect both ends of the coil parts connected in series and one of all the coil parts to the first conductive path, and to connect the others to the second conductive path.

5. The polyphase motor switching device according to claim 1, wherein the coil parts placed outside the range of use by the switching unit are dispersed in a circumferential direction.

6. (canceled)

7. The polyphase motor switching device according to claim 1, further including a control device that controls operation of the switching unit.

8. The polyphase motor switching device according to claim 2, wherein the coil parts placed outside the range of use by the switching unit are dispersed in a circumferential direction.

9. The polyphase motor switching device according to claim 2, further including a control device that controls operation of the switching unit.
